(19) United States
(12) Patent Application Publication
(10) Pub. No.: US 2009/0308565 A1
(43) Pub. Date: Dec. 17, 2009

(54) CART OCCUPANT COOLING SYSTEM

(76) Inventors: Robert G. JONES, Hickory Valley, TN (US); Billy W. Clayton, Bolivar, TN (US)

Correspondence Address: BERENATO & WHITE, LLC, 6550 ROCK SPRING DRIVE, SUITE 240, BETHESDA, MD, 20817, US

(21) Appl. No.: 12/482,659

(22) Filed: Jun. 11, 2009

Related U.S. Application Data
(60) Provisional application No. 61/061,360, filed on Jun. 13, 2008.

(51) Int. Cl. B60H 1/32; F28D 15/00

(52) U.S. Cl. 165/41; 165/104.34

(57) ABSTRACT

An open cart occupant cooling system is disclosed. The system includes a number of fan(s) each capable of delivering about 900 cfm of air flow, in a simulated 10 mph breeze, to the seating positions of the occupants. The fans are clamped to the cart roof struts, or other mounts, so as to direct a stream of cooling air toward the cart occupant(s). The fans are activated by a pressure or proximity sensitive switch upon an occupant alighting onto the seat of the cart. The cooling system can be retrofit with temporary hand operated clamps to mount the fans and be operated with either a plug in or self-contained rechargeable electrical supply and, if so desired, wired to a seat cushion operated pressure switch.

This application claims the benefit of prior filed U.S. Provisional Application, Ser. No. 61/061,360, filed Jun. 13, 2008.

### BACKGROUND OF THE INVENTION

1. Field of Invention

The present invention relates to open air cart type transports fitted with occupant fan cooling systems. Particularly, this invention relates to Golf carts equipped with paired, independently and automatically operable cooling fans directed at the respective occupants. The inventive system can be original equipment, or retrofit to existing cart type vehicles.

2. Discussion of the Prior Art

Golf is enjoyed the world over by many enthusiasts. In the United States it has becomes a staple feature of the warmer months when it is played frequently. To speed the play of game and also enable those with less stamina to play more often, golf carts are used to assist players in playing shot to shot and hole to hole. Carts may be either gas or electrically operated, more often electrically, with powerful ((36V or 48V) deep cycle rechargeable battery sets. Even those that are gas powered include start/stop capacity with 12V batteries for starting functions. Around the course, service carts are also present, for service personnel attending to watering, hole placement, monitoring speed of play, and often times selling drinks, sandwiches, and other items.

All of these carts type vehicles (including tractors, RTV, etc.) suffer from the problem of total climate exposure. Although some may be equipped with foul weather curtain style protection for the occupants (and their clubs), when it is hot, sunny, and relatively still, the heat, especially in the more tropical and desert climates, can make golfing and/or any activity (construction, facility maintenance, etc.) involving an outdoor cart an unwelcome activity. Although most carts do have a roof with supporting struts, the shade provided can only accomplish so much in terms of relief from the sun and heat. When the cart is driven, some air is stirred, but with the wind screen in place, even this may be hindered. For construction uses, in the case of small tractors performing short cycle work (digging/dumping/spreading), little speed may be generated, so even the air stirred by movement may be little or none.

Myriad solutions to above the issues have been proposed in the past. Most of the solutions, however, either exceed the need (portable air conditioners/fluid based misters/ice chests/driven compressors) and are needlessly complex, or are simply a fan clamped in the breeze near a golfer's head/face/neck. The prior complex solutions are, for the most part, not reasonable portable for shear size and weight (one even includes a 12V auto battery, described as easily portable!) or connection complexity. The truly portable ones are near useless in terms of providing adequate relief and would be hard pressed to provide any genuine relief.

In view of the foregoing, cart occupant cooling that is fan based (air movement), inexpensive, convenient, and easily moved from cart-to-cart would be desirable.

### SUMMARY OF THE INVENTION

It is an object of the present invention to overcome the shortcomings of the other known solutions to hot weather carting activity by providing a cost effective, simple solution to cool occupants with individually directed and operated cooling fans.

Most open air cart type transports include a roof with supporting struts. In most cases the roof is provided as a modest form of weather protection but, in some cases, these roofs and struts are a necessity and serve a function in role over protection where the occupants are belted or otherwise held in position (RTVs, tractors, etc.). In either case, the roof struts and/or the roof itself, can serve as mounting support(s) for the present system's fan(s) by virtue of clamps that secure the fan frame(s) directly to the struts and/or a roof or strut mounted bar. The wires used to power the fans can be run through the inside of the strut or run separately through suitable conduit to a seat mounted switch, or automatic proximity switch, that transfers power to the fan associated with the seat or occupant. The fan can, if so desired by the user, be switched to any of a variety of pre-selected speeds so that, when activated, it runs at a predetermined speed. The fan(s) can be turned fully off as well.

The selected fan(s) are sized (about 12 inch and up) so as to create the equivalent of a 10 mph breeze, or about 900 cubic feet or air per minute, directed at each individual occupant. Connection of the seat cushion switch to the battery can be through alligator or other type temporary clamp set-up but, most advantageously, a cart or other equipment item would be pre-equipped with a non-switched common 12 volt DC plug so that the fan system could be easily retrofit to a variety of equipment and carts.

Alternatively, the fans may be completely self contained with rechargeable batteries (of the portable powertool variety, 9V+, charged separately or with an on-board solar trickle charger), and auto-set proximity sensors (auto-door opening, auto security light turn-on, etc.) for switching the fans on/off. Once the fans are clamped into position and equipped with batteries, the fans operate when an occupant is proximate and turn-off when that is no longer the case. The complete cooling system may be associated with a golfer's usual gear (clubs, umbrella, shoes, towel, etc.) and be mounted cart-to-cart at various courses played, whenever played.

### BRIEF DESCRIPTION OF THE DRAWINGS

FIG. 1 is a rearward perspective view of the invented system mounted to a golfing cart.

FIG. 2 is a side view of the system mounted in FIG. 1.

FIG. 3 shows a pressure actuated switch suitable for activating fan operation.

FIG. 4 shows the seat in position to receive an occupant and activate the suspended fans.

FIG. 5 is circuit schematic showing a wiring diagram for an embodiment of the present invention.

FIG. 6 is a side view of a portable battery powered version with solar re-charger and proximity switch on/off switch.

FIG. 7 shows an alternative embodiment of a seat switch used in the cooling system.

FIG. 8 shows a suitable lever action switch and spring for use in the FIG. 7 embodiment.

FIG. 9 shows a rear view of a roof strut mounted support bar for the fan mounts.

FIG. 10 shows a rear view of a roof mounted support bar for the fan mounts.

### DESCRIPTION—PREFERRED EMBODIMENT

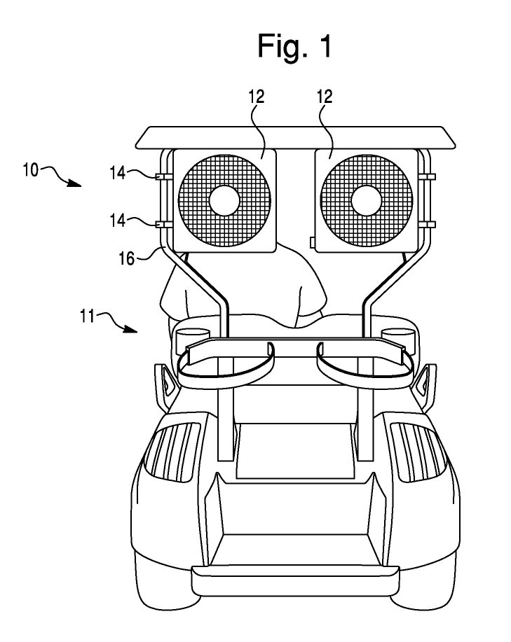

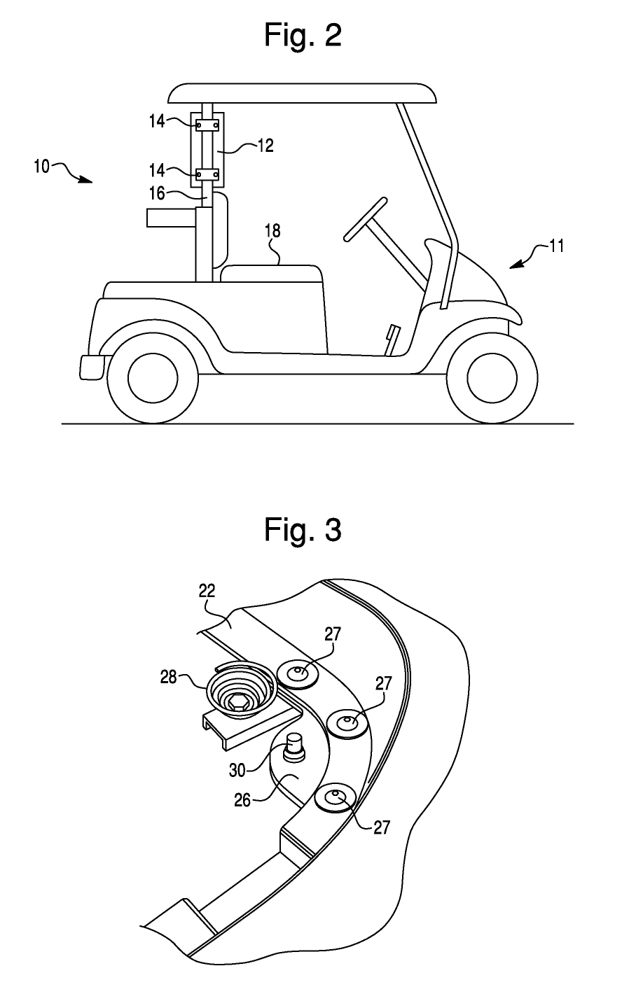

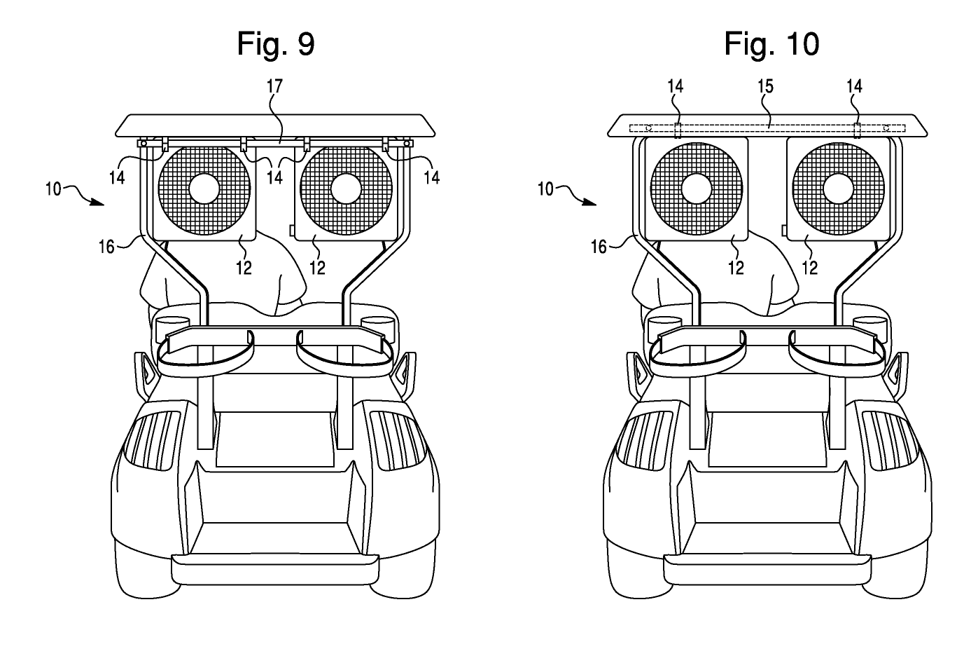

In the preferred embodiment of this invention, with reference to FIGS. 1, 2, 9, and 10, the system 10 ideally includes a pair of 12 inch diameter 12V shrouded fans 12 for a two occupant cart 11. The fans 12 are clamped using clamps 14 to vertical members 16 of the cart 11 roof. In FIGS. 9 and 10, the fans are alternatively mounted by clamps 14 to a roof strut-to-strut support or tie bar 17, or a roof mounted support bar 15, respectively.

The fans 12 are oriented to provide a powerful broadly directed air stream toward the occupants in the cart's seat 18, i.e., a genuine 10 mph breeze simulation. In the embodiment shown, the fans 12 are 12 inch diameter in size and are associated from the fan perimeter frame/shroud with the roof struts 16 by split clamps 14. These clamps 14 may be of any variety of attaching or clamping mechanisms to simply but securely and vibration free attach the surrounding frames of fan 12 to the roof struts 16. An inserted foam rubber damper is usually sufficient to eliminate vibration. The wiring used to connect between the fan motors 34, 36 and the battery 32 can be 14 gauge, as in this embodiment, but can be sized larger or smaller depending on the size of the fans and the power demands anticipated in use (i.e, for 4 or more occupant carts, like courtesy carts, etc.).

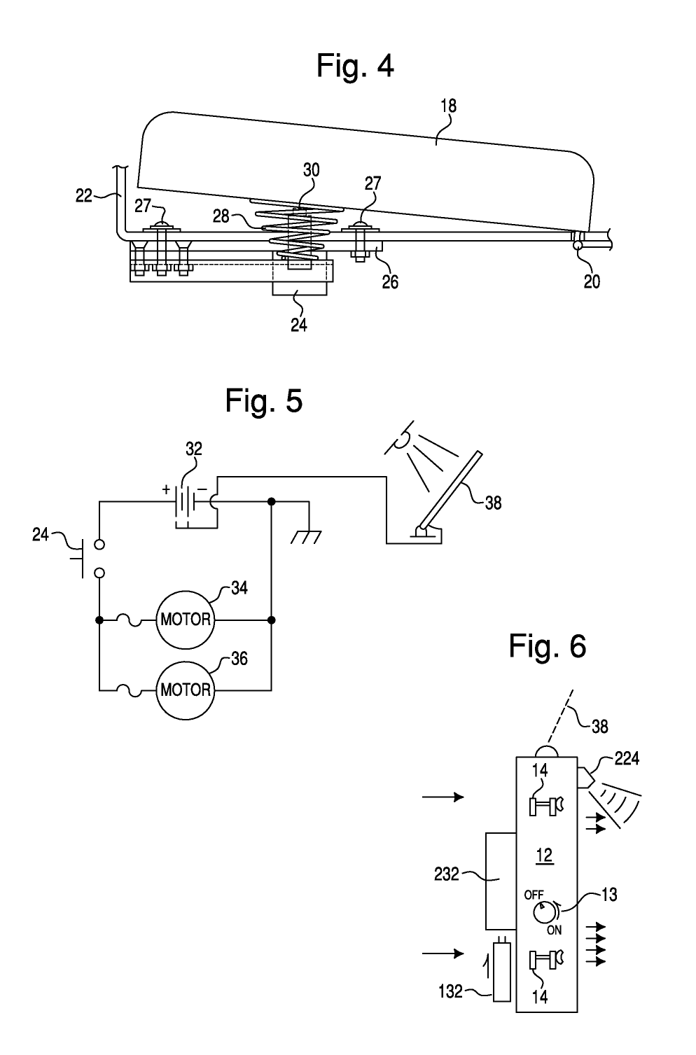

The switching system used to complete the circuit, FIG. 5, between the fans and the battery can include a switch 24, 124 operated by a plunger 30, or lever 125, as shown in the various embodiments and using the components shown in FIGS. 3, 4, 7, and 8. In FIGS. 3 and 4, the switch and plunger is mounted along an edge of a liftable seat 18 using mounting screws 27, so that a spring 28, or other bias mechanism, can maintain the seat 18 in a position so as to prevent activation of the switch 24 by driving plunger 30 downwardly. However, when an occupant takes up position in seat 18, the plunger is pushed downwardly activating switch 24 and completing the circuit, FIG. 5, so as to drive the fans 12 and the resulting air stream. When the cart occupant leaves the seat 18, the fan 12 ceases operation by virtue of the spring raising the seat and disengaging plunger 30.

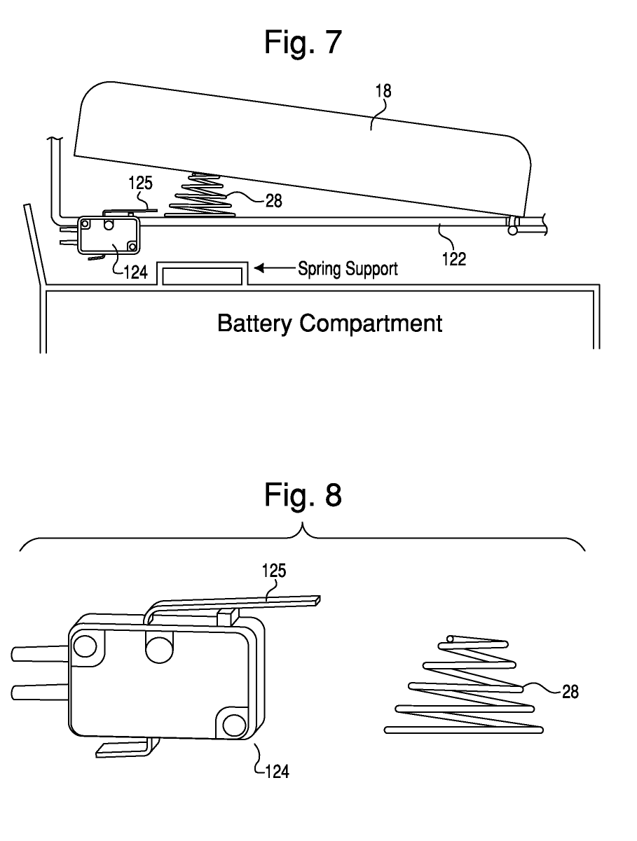

In FIG. 7 an alternative lever action switch 124 is used in combination with the spring 28 biased pivoting seat 18. The switch 124 in this version does not include a plunger but rather mounts to the seat frame 122 perimeter where the seat 18 edge can engage and disengage the extending lever 125 of the switch 124. In operation, the system mimics the operation of the FIG. 3, 4 version.

The circuit shown in FIG. 5 can be further equipped with a second series switch to turn the fans off, regardless of the position of the seat and spring biased switch 24 or 124. In addition, a fan mounted rheostat type or multi-level current control 13 may also be included to vary the speed of the fans in an infinitely variable manner. The rheostat or multi-speed control may also include an off position.

In the self-contained clamped version, FIG. 6, the same circuit as in FIG. 5 is used, but switch 24 becomes an auto proximity sensor 224 (of the known infra-red or radio wave variety) to sense a cart occupant, and the battery 132 is not associated with the cart, but rather is, instead, mounted directly to the fan frame grating in a receiver compartment 232 not unlike a portable power-tool (drill, saw, nailing gun, etc.). The batteries 132 can be removed and recharged, with ready replacements brought along on a given outing (18 holes can take 4+ hours!). Alternatively, or in addition, the batteries may be charged by a mounted solar charger 38. The solar array can be mounted to the fan frame or temporarily attached to the cart 11 body or roof.

In another embodiment of the seat switch alternative, the spring biased switch 24, 124 may be replaced by a fairly flat seat cushion equipped with separated contacts within the cushion that make contact when an occupant is seated thereon. This alternate embodiment would operate in the same way as the plunger switch 24 is actuated in the shown version, but with the switch contained inside each occupant cushion and placed on top of seat 18.

If a cart or other open air vehicle is equipped with a 12V un-switched accessory plug-in (many already come so equipped for cell phone recharging, laptop use, etc.), a wired cart battery powered cooling system 10 may be retrofit to a cart quickly and easily by plugging in the 12V power cord, placing the in-series respective switch equipped cushions in place, clamping the fans in place using split clamps with butterfly style nuts to place the clamps without necessity for tools. Alternatively, the proximity sensor version, which is completely self-contained, can be equipped with fresh batteries, clamped in place, used, and later removed or taken to mount on another vehicle.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

What is claimed is:

1. An open air roof equipped cart occupant cooling system, comprising:
a framed fan capable of moving about 900 cfm of air flow equipped with clamps along a perimeter of said frame to clamp said fan into a position proximate a seating position on said cart;
a cart occupant responsive electrical switch mounted to said cart and electrically connected so as to initiate and stop operation of said fan in response to a cart occupant being in position on said cart to benefit from said air flow; and,
an electrical supply electrically connected to said fan through said electrical switch so as to operate said fan when said switch is in an on position and to cease operation when said switch is in an off position.

2. A cooling system as in claim 1, wherein:
said electrical supply is contained on said fan frame.

3. A cooling system as in claim 1, wherein:
said cart occupant responsive switch is a seat mounted switch that is moved between an on position when said occupant is seated in a traveling position in said cart and in an off position when said occupant is removed from said traveling position.

4. A cooling system as in claim 1, wherein:
said cart occupant responsive switch is a proximity sensing switch mounted to a forward air outflow portion of said fan that is directed toward a cart occupant seating position so as to sense the presence or absence of a cart occupant and to initiate fan operation accordingly.

5. A cooling system as in claim 4, wherein:
said electrical supply is self-contained and recharged by a solar powered recharger connected thereto.

6. A cooling system as in claim 1, wherein:
said fan is clamped directly to roof support struts associated with a roof of said cart.

7. A cooling system as in claim 1, wherein:
said fan is clamped to a support bar mounted to a roof of said cart.

8. A cooling system as in claim 1, wherein:
said fan is clamped to a support bar connected between roof struts associated with a roof of said cart.
